(19) United States
(12) Patent Application Publication
(10) Pub. No.: US 2023/0339302 A1
(43) Pub. Date: Oct. 26, 2023

(54) VEHICLE FRAME WITH AN INTEGRATED BATTERY ENCLOSURE

(71) Applicant: GM GLOBAL TECHNOLOGY OPERATIONS LLC, Detroit, MI (US)

(72) Inventors: Alexander M. BILINSKI, Avoca, MI (US); Phillip Daniel Hamelin, Clarkston, MI (US)

(21) Appl. No.: 17/725,858

(22) Filed: Apr. 21, 2022

(51) Int. Cl. B60K 1/04; B62D 25/20

(52) U.S. Cl. CPC B60K 1/04; B62D 25/2036; B60K 2001/0438

(57) ABSTRACT

A vehicle frame includes a first vehicle frame side rail and a second vehicle frame side rail spaced laterally from the first vehicle frame side rail. An upper battery enclosure having an upper wall and a pair of side walls. A cross beam extends through a respective pair of apertures in the pair of side walls of the battery enclosure and through an aperture in the first vehicle frame side rail and an aperture in the second vehicle frame side rail. A battery tray is secured below the pair of side walls of the upper battery enclosure.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a vehicle frame with an integrated battery enclosure.

Current industry battery frame designs rely on a battery pack that have a separate battery enclosure that is loaded to a traditional vehicle frame. The pack requires internal load clearance to build the module and internal components. The battery pack requires load clearance to the frame in general assembly. The combination of the clearances reduces a volume for cells, which reduces pack energy.

This present disclosure integrates the frame and battery enclosure as one to provide additional volume for battery energy. This present disclosure reduces the internal clearance required to build the pack and uses the space to eliminate general assembly load clearances. It reduces clearances allocated for draft angles of the cover and provides additional space for pack energy

### SUMMARY

This section provides a general summary of the disclosure, and is not a comprehensive disclosure of its full scope or all of its features.

A vehicle frame includes a first vehicle frame side rail and a second vehicle frame side rail spaced laterally from the first vehicle frame side rail. An upper battery enclosure having an upper wall and a pair of side walls. A cross beam extends through a respective pair of apertures in the pair of side walls of the battery enclosure and through an aperture in the first vehicle frame side rail and an aperture in the second vehicle frame side rail. A battery tray is secured below the pair of side walls of the upper battery enclosure.

A vehicle frame includes a first vehicle frame side rail and a second vehicle frame side rail spaced laterally from the first vehicle frame side rail. A pair of enclosure panels extend between the first vehicle frame side rail and the second vehicle frame side rail. A shear panel is welded and sealed to a respective top surface of each of the first vehicle frame side rail and the second vehicle frame side rail and to the pair of enclosure panels. A battery tray is secured to the first vehicle frame side rail and the second vehicle frame side rail.

A vehicle frame includes a first vehicle frame side rail and a second vehicle frame side rail spaced laterally from the first vehicle frame side rail. An enclosure panel extends between the first vehicle frame side rail and the second vehicle frame side rail. A battery tray is secured to the first vehicle frame side rail and the second vehicle frame side rail. A seal is disposed between the battery tray and each of the first vehicle frame side rail, the second vehicle frame side rail and the at least one enclosure panel.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of a vehicle frame with an integrated battery enclosure according to the principles of the present disclosure;

FIG. 2 is an exploded perspective view of the vehicle frame with an integrated battery enclosure of FIG. 1;

FIG. 3 is a cross-sectional view of the vehicle frame with an integrated battery enclosure of FIG. 1;

FIG. 4 is a schematic view of the vehicle frame with an integrated battery enclosure of FIG. 1 in a disassembled state;

FIG. 5 is a schematic view of an alternative embodiment of a vehicle frame with an integrated battery enclosure in a disassembled state;

FIG. 6 is an exploded perspective view of the vehicle frame with an integrated battery enclosure of FIG. 5;

FIG. 7 is a schematic view of a further alternative embodiment of a vehicle frame with an integrated battery enclosure in a disassembled state; and

FIG. 8 is an exploded perspective view of the vehicle frame with an integrated battery enclosure of FIG. 7.

In the drawings, reference numbers may be reused to identify similar and/or identical elements.

### DETAILED DESCRIPTION

Example embodiments will now be described more fully with reference to the accompanying drawings.

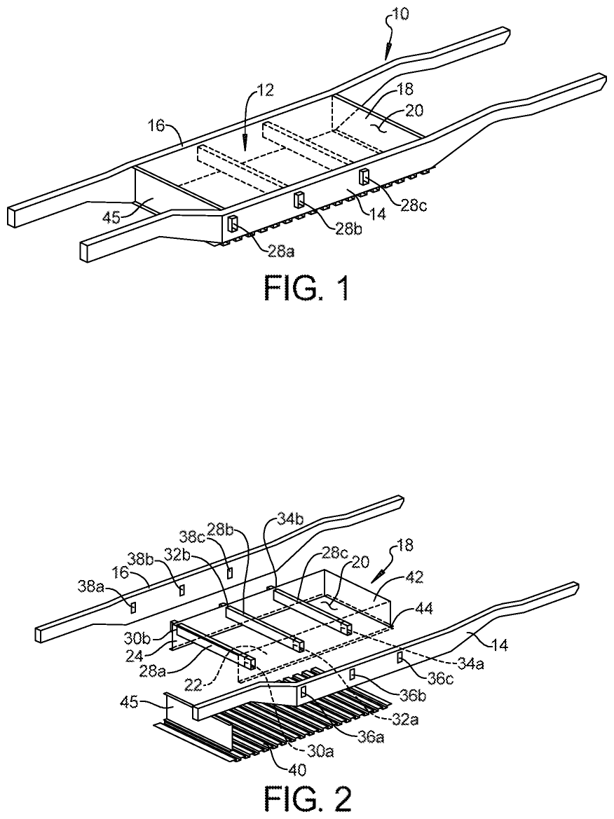

With reference to FIGS. 1-4, a vehicle frame 10 with an integrated battery enclosure 12 according to a first embodiment will be described. The vehicle frame 10 includes a first vehicle frame side rail 14 and a second vehicle frame side rail 16. As best shown in FIG. 2, an upper battery enclosure 18 is disposed between the first vehicle frame side rail 14 and the second vehicle frame side rail 16. The upper battery enclosure 18 includes an upper wall 20 and a pair of side walls 22, 24. The upper battery enclosure 18 can be made from sheet metal, plastic or other engineering material. A plurality of cross beams 28a-c (three are shown) extend through a respective pair of apertures 30a, 30b; 32a, 32b; 34a, 34b in the pair of side walls 22, 24 of the battery enclosure and through a respective aperture 36a, 36b, 36c in the first vehicle frame side rail 14 and a respective aperture 38a, 38b, 38c in the second vehicle frame side rail 16. The connections between the beams 28a-c and the upper battery enclosure can be welded and sealed. A battery tray 40 is secured below the pair of side walls 22, 24 of the upper battery enclosure 18.

The upper battery enclosure 18 further includes a rear wall 42 and an outwardly extending flange 44 extending from the pair of sidewalls 22, 24 and the rear wall 42. An additional enclosure panel 45 can be used to enclose a forward end of the upper battery enclosure 18. As best shown in FIG. 4, a seal 46 can be provided between the battery tray 40 and the outwardly extending flange 44 of the upper battery enclosure 18 and between the battery tray and the enclosure panel 45. In addition, the enclosure panel 45 can be sealingly engaged with the forward end of the upper battery enclosure 18. As shown in FIG. 4, an optional shear panel 48 can be connected to the first vehicle frames side rail 14 and the second vehicle frame side rail 16 in order to provide additional lateral strength and frame rigidity. The shear panel 48 can be connected to the side rails 14, 16 by welding, fasteners or other connection techniques. A vehicle floor panel 50 is disposed above the first vehicle frames side rail 14, the second vehicle frame side rail 16, the battery enclosure 12 and the shear panel 48 if present.

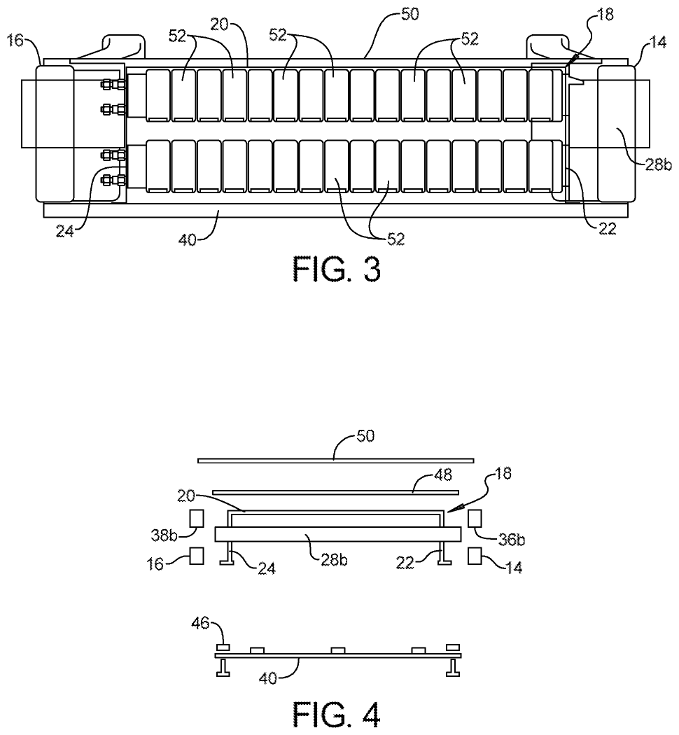

With reference to FIG. 3, a plurality of battery cells 52 are supported on the battery tray 40 and disposed within the battery enclosure 12. By integrating the battery enclosure 12 into the vehicle frame 10, a volume of the battery enclosure 12 can be maximized. The maximization of the volume of the battery enclosure 12 allows for a larger number of battery cells 52 to be packaged within the battery enclosure 12 and thus provides an increased energy density for the pack and provides additional vehicle range. The enclosure 12 is part of the frame structure 10 and provides sealing for the battery back. By integrating the enclosure 12 into the vehicle frame can also result in mass reduction without sacrificing frame strength.

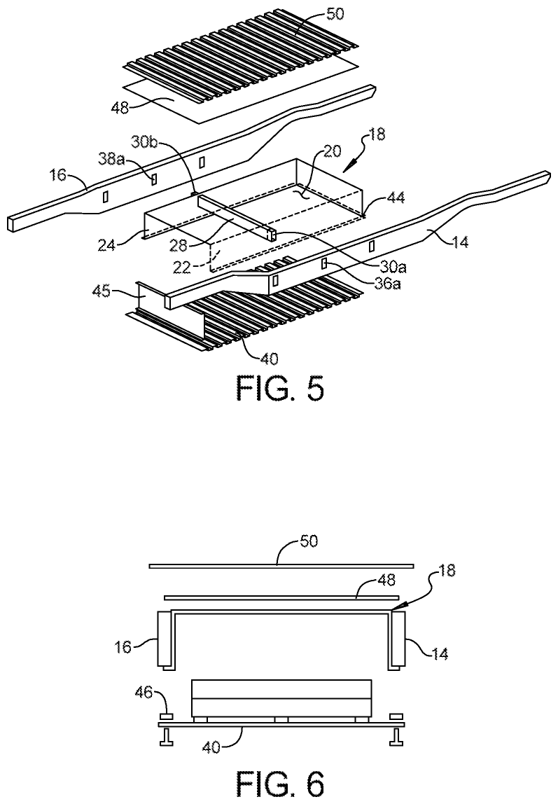

With reference to FIGS. 5 and 6, a vehicle frame 110 with an integrated battery enclosure 12 according to a second embodiment will be described wherein the same reference numerals are used to describe the same or similar elements. The vehicle frame 110 includes a first vehicle frame side rail 14 and a second vehicle frame side rail 16. As best shown in FIG. 2, an upper battery enclosure 18 is disposed between the first vehicle frame side rail 14 and the second vehicle frame side rail 16. The upper battery enclosure 18 includes an upper wall 20 and a pair of side walls 22, 24. A reduced number of optional cross beams 28 (one is shown) sealingly extend through a respective pair of apertures 30a, 30b in the pair of side walls 22, 24 of the battery enclosure and through a respective aperture 36a in the first vehicle frame side rail 14 and a respective aperture 38a in the second vehicle frame side rail 16. The connection of the cross beams 28 to the upper battery enclosure and to the first and second vehicle frame side rail can be welded and sealed. A battery tray 40 is secured below the pair of side walls 22, 24 of the upper battery enclosure 18.

The upper battery enclosure 18 further includes a rear wall 42 and an outwardly extending flange 44 extending from the pair of sidewalls 22, 24 and the rear wall 42. An additional enclosure panel 44 can be used to enclose a forward end of the upper battery enclosure 18. As best shown in FIG. 6, a seal 46 can be provided between the battery tray 40 and the outwardly extending flange 44 of the upper battery enclosure 18 and between the battery tray and the enclosure panel 44. In addition, the enclosure panel 44 can be sealingly engaged with the forward end of the upper battery enclosure 18. A shear panel 48 is connected to the first vehicle frames side rail 14 and the second vehicle frame side rail 16 in order to provide additional lateral strength and frame rigidity. The shear panel 48 can be connected to the side rails 14, 16 by welding, fasteners or other connection techniques and reduces the need for the additional cross beams used in the first embodiment. A vehicle floor panel 50 is disposed above the first vehicle frames side rail 14, the second vehicle frame side rail 16, the battery enclosure 12 and the shear panel 48.

A plurality of battery cells 52 are supported on the battery tray 40 and disposed within the battery enclosure 12. By integrating the battery enclosure 12 into the vehicle frame 10 and further eliminating additional cross beams, a volume of the battery enclosure 12 can be maximized. The maximization of the volume of the battery enclosure 12 allows for a larger number of battery cells 52 to be packaged within the battery enclosure 12 and thus provides an increased energy density for the pack and provides additional vehicle range. The enclosure 12 is part of the frame structure 10 and provides sealing for the battery back. By integrating the enclosure 12 into the vehicle frame can also result in mass reduction without sacrificing frame strength.

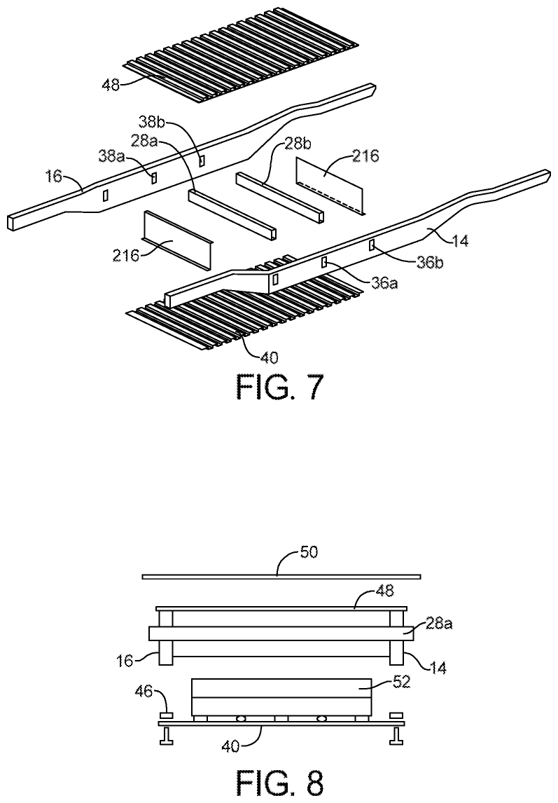

With reference to FIGS. 7 and 8, a vehicle frame 210 with an integrated battery enclosure 212 according to a first embodiment will be described wherein the same reference numerals are used to describe the same or similar elements. The vehicle frame 210 includes a first vehicle frame side rail 14 and a second vehicle frame side rail 16. As best shown in FIG. 7, a pair of enclosure panels 216 are disposed between the first vehicle frame side rail 14 and the second vehicle frame side rail 16 and at opposite ends of the battery enclosure 212. A plurality of cross beams 28a-b (two are shown) extend through a respective aperture 36a, 36b in the first vehicle frame side rail 14 and a respective aperture 38a, 38b in the second vehicle frame side rail 16. The connections between the cross beams 28a-28b can be welded and sealed. A battery tray 40 is secured below the first and second vehicle frame side rails 14, 16.

As best shown in FIG. 8, a seal 46 can be provided between the battery tray 40 and the first and second vehicle frame side rails 14, 16 and between the battery tray and the pair of enclosure panels 216. In addition, the pair of enclosure panels 216 can be sealingly engaged with first vehicle frame side rail 14 and the second vehicle frame side rail 16. A shear panel 48 is sealingly connected to the first vehicle frames side rail 14 and the second vehicle frame side rail 16 and to the pair of enclosure panels 44 in order to provide additional lateral strength and frame rigidity and to define an upper surface of the battery enclosure 212. The shear panel 48 can be connected to the side rails 14, 16 by welding, fasteners or other connection techniques. A vehicle floor panel 50 is disposed above the first vehicle frames side rail 14, the second vehicle frame side rail 16 and the shear panel 48.

A plurality of battery cells 52 are supported on the battery tray 40 and disposed within the battery enclosure 12. By integrating the battery enclosure 12 into the vehicle frame 10, a volume of the battery enclosure 12 can be maximized. The maximization of the volume of the battery enclosure 12 allows for a larger number of battery cells 52 to be packaged within the battery enclosure 12 and thus provides an increased energy density for the pack and provides additional vehicle range. The enclosure 12 is part of the frame structure 10 and provides sealing for the battery back. By integrating the enclosure 12 into the vehicle frame 10 can also result in mass reduction without sacrificing frame strength.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A vehicle frame, comprising:
a first vehicle frame side rail;
a second vehicle frame side rail spaced laterally from the first vehicle frame side rail;
an upper battery enclosure disposed between the first vehicle frame side rail and the second vehicle frame side rail and the upper battery enclosure having an upper wall and a pair of side walls;
at least one cross beam extending through a respective pair of apertures in the pair of side walls of the battery enclosure and through an aperture in the first vehicle frame side rail and an aperture in the second vehicle frame side rail; and
a battery tray secured below the pair of side walls of the upper battery enclosure.

2. The vehicle frame according to claim 1, wherein the at least one cross beam includes a plurality of cross beams extending through a plurality of respective pairs of apertures in the pair of side walls of the battery enclosure and through a respective one of a plurality of apertures in the first vehicle frame side rail and a respective one of a plurality of apertures in the second vehicle frame side rail.

3. The vehicle frame according to claim 1, further comprising a seal between the battery tray and the side walls of the upper battery enclosure.

4. The vehicle frame according to claim 1, further comprising a vehicle floor panel disposed above the upper battery enclosure.

5. The vehicle frame according to claim 1, further comprising a plurality of battery cells supported on the battery tray.

6. The vehicle frame according to claim 1, further comprising a shear panel disposed above the upper battery enclosure and connected to the first vehicle frame side rail and the second vehicle frame side rail.

7. The vehicle frame according to claim 6, wherein the shear panel is welded to the first vehicle frame side rail and the second vehicle frame side rail.

8. The vehicle frame according to claim 1, further comprising at least one enclosure panel extending between an end of the pair of side walls of the battery enclosure.

9. A vehicle frame, comprising:
a first vehicle frame side rail;
a second vehicle frame side rail spaced laterally from the first vehicle frame side rail;
a pair of enclosure panels extending between the first vehicle frame side rail and the second vehicle frame side rail;
a shear panel welded and sealed to a respective top surface of each of the first vehicle frame side rail and the second vehicle frame side rail and to the pair of enclosure panels;
and
a battery tray secured to the first vehicle frame side rail and the second vehicle frame side rail.

10. The vehicle frame according to claim 9, further comprising at least one cross beam extending through an aperture in the first vehicle frame side rail and through an aperture in the second vehicle frame side rail.

11. The vehicle frame according to claim 9, further comprising a seal between the battery tray and each of the first vehicle frame side rail, the second vehicle frame side rail and the pair of enclosure panels.

12. The vehicle frame according to claim 9, further comprising a vehicle floor panel disposed above the shear panel.

13. The vehicle frame according to claim 9, further comprising a plurality of battery cells supported on the battery tray.

14. A vehicle frame, comprising:
a first vehicle frame side rail;
a second vehicle frame side rail spaced laterally from the first vehicle frame side rail;
at least one enclosure panel extending between the first vehicle frame side rail and the second vehicle frame side rail;
a battery tray secured to the first vehicle frame side rail and the second vehicle frame side rail; and
a seal between the battery tray and each of the first vehicle frame side rail, the second vehicle frame side rail and the at least one enclosure panel.

15. The vehicle frame according to claim 14, further comprising at least one cross beam extending through an aperture in the first vehicle frame side rail and through an aperture in the second vehicle frame side rail.

16. The vehicle frame according to claim 14, further comprising a shear panel welded and sealed to a respective top surface of each of the first vehicle frame side rail, the second vehicle frame side rail and to the at least one enclosure panel.

17. The vehicle frame according to claim 16, further comprising a vehicle floor panel disposed above the shear panel.

18. The vehicle frame according to claim 14, further comprising a plurality of battery cells supported on the battery tray.

19. The vehicle frame according to claim 14, further comprising an upper battery enclosure disposed between the first vehicle frame side rail and the second vehicle frame side rail and the upper battery enclosure having an upper wall and a pair of side walls.

20. The vehicle frame according to claim 19, wherein the seal is disposed between the battery tray and the pair of side walls of the upper battery enclosure.
